(19) United States
(12) Patent Application Publication
(10) Pub. No.: US 2013/0055116 A1
(43) Pub. Date: Feb. 28, 2013

(54) THEME VARIATION ENGINE

(71) Applicants: Jonathan Fred Kern, Kirkland, WA (US); Lionel A. Robinson, Bothell, WA (US); Aditi Mandal, Bothell, WA (US); Thomas Richard Allen Ham, Seattle, WA (US); Ashok Kuppusamy, Seattle, WA (US); Richard Eric Andeen, Seattle, WA (US); Mario Roberto Baumann, Kirkland, WA (US)

(72) Inventors: Jonathan Fred Kern, Kirkland, WA (US); Lionel A. Robinson, Bothell, WA (US); Aditi Mandal, Bothell, WA (US); Thomas Richard Allen Ham, Seattle, WA (US); Ashok Kuppusamy, Seattle, WA (US); Richard Eric Andeen, Seattle, WA (US); Mario Roberto Baumann, Kirkland, WA (US)

(73) Assignee: MICROSOFT CORPORATION, Redmond, WA (US)

(21) Appl. No.: 13/217,241

(22) Filed: Aug. 25, 2011

(51) Int. Cl. G06F 3/048

(52) U.S. Cl. 715/762

(57) ABSTRACT

A theme variation engine generates mock web pages based on selected user inputs defining thematic aspects of a web site. The inputs may include a color, which is used to derive a color palette used in generating the mock web pages. The input can also include an image, which can be transformed in various ways, and a web page layout that determines where the transformed image may be placed. The theme variation engine uses the inputs to generate various mock web pages that the user can select and have the associated thematic parameters saved for future use. Alternatively, certain thematic parameters associated with the selected mock web pages can be used for generating additional mock web pages. The selected thematic parameters can then be used to generate the web site for the user. A computer system may implement execute instructions using a theme variation engine program module.

### BACKGROUND

Designing web sites is a multi-disciplinary task that frequently can exceed the capabilities of individuals who are otherwise experienced with using computers. An effective web site for even a modest e-commerce or other application involves designing a number of web pages that are interesting, easy to use, and informative. This requires the web designer to have at least a rudimentary understanding of graphics design, so as to present images in a manner that are easy to comprehend, and using color combinations that are aesthetically pleasing. Certain color combinations may be difficult to view on a computer screen compared to other media, or may not be effective in conveying information. Other aspects of graphic design that are relevant include: font size, image selection, and graphical effects. A web page that is too “busy” can be an ineffective marketing tool, and discourage viewers from returning.

In light of these requirements, it is not surprising that many individuals desiring to offer a web site are not readily able to design an effective site. Such individuals may be limited to using pre-defined templates, which may be offered by their web site hosting provider, or using a pre-defined web site created by an off-the-shelf software package. The resulting web site looks very similar to other web sites based on the same template or software package. Alternatively, a team of individuals comprising a programmer and graphics designer can be hired who collectively can develop a custom, or at least semi-custom, web site, but this can be expensive.

Each of these alternatives is undesirable as being costly or ineffective. Therefore, there is a need for the ability for users to create semi-custom web sites in an easy manner. It is with respect to these and other considerations that the disclosure made herein is presented.

### SUMMARY

The skill in selecting an appropriate color scheme may not be readily within the capabilities of the web designer, but are nevertheless an important part of web design. By using the theme variation engine disclosed herein, the user may be assisted in generating various thematic parameters of a web site to provide a unique and pleasing appearance. The theme variation engine can incorporate and apply various rules to define what color palette should be created based on user inputs. In certain embodiments, the user may provide input to the rule selection or request the theme variation engine select colors, or provide other sources of input on which the colors should be based, such as an image or logo. The theme variation engine can also incorporate the image into the web design and select web page layouts.

In one embodiment disclosed herein, a system for generating thematic parameters for use in a web site includes a central processing unit, a network interface unit configured to receive input from a user, and a mass storage device storing a theme variation engine program module. The theme variation engine program module includes instructions that when executed, cause the central processing unit to receive input indicating a color from the user to be used in the web site. The instructions further cause the central processing unit to determine a color palette using the color, wherein the color palette includes at least two colors, where one of the colors is indicated by the user, and the other color is one of an accent color, a complimentary color, or an analogous color. The instructions further cause input to be received indicating a web page from the user, and a first set that includes at least two mock web pages to be generated that incorporate the web page layout and the color palette. The instructions cause a second set of mock web pages, which can be a subset of the first set of mock web pages, to be displayed to the user.

In another embodiment disclosed herein, a computer implemented method is provided to generate a set of thematic parameters for a web site that includes receiving input from the user indicating a color to be used in the web site. A first color palette is determined based on the color, where the color palette includes at least two colors, where one color is the color provided by the user and the other color is an accent color, a complimentary color, or an analogous color. A plurality of mock web pages are generated that that include a first mock web page incorporating a first web page layout and the first color palette, and a second mock web page incorporating a second web page layout and the first color palette. The plurality of mock web pages are then displayed to the user.

In yet another embodiment disclosed herein, a computer readable storage medium has computer readable instructions stored there upon, which when executed by a computer cause the computer to receive input from the user indicating an image file, select a color from the image file, wherein the color is a predominate color in the image file, and generate a first color palette comprising a plurality of colors, where one of the plurality of colors is the color from the image file. The instructions then cause the computer to receive input from the user indicating a web page layout and generate a first plurality of mock web pages incorporating the web page layout and the first color palette, and display the first plurality of mock web pages to the user.

It should also be appreciated that the above-described subject matter might also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a high level process flow for one embodiment for generating mock web pages according to the disclosure herein.

FIG. 2 is a process flow diagram illustrating one embodiment for transforming an image according to the disclosure herein.

FIG. 3 is a process flow diagram illustrating one embodiment for selecting a color palette according to the disclosure herein.

FIGS. 4A and 4B illustrate embodiments of a user interface for receiving input from a user according to the disclosure herein.

FIG. 5 is one embodiment of a user interface for receiving input from a user along with generated mock web pages presented to the user according to the disclosure herein.

FIG. 6 is another embodiment of a user interface for presenting mock web pages to the user according to the disclosure herein.

FIG. 7 is one embodiment of the process flow for generating mock web pages according to the disclosure herein.

FIG. 8 illustrates one embodiment of a computer executing instructions for accomplishing the process flows according to the disclosure herein.

### DETAILED DESCRIPTION

The following detailed description is directed to technologies for developing semi-custom web sites by a user providing color and/or image information that are then used to generate a set of theme variations for a web site. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system, computer-readable storage medium, and computer-implemented methodology for generating thematic data will be presented.

Users desiring to create a web site for a particular application, such as an e-commerce or an informational application, may not have the capabilities to design and develop web sites on their own. This is true for many small business owners or individuals that have limited, computer-related capabilities. To aid these users, pre-developed templates can be used to design a web site, but the appearance of such web sites is very similar to other web sites based on the same set of templates. The designers of such web sites typically desire an enhanced level of distinctiveness from other web sites having similar functionality. For example, a small business owner selling home-made candies via a web site may have similar functionality as to a web site selling home-made crafts, but each business owner would like to have a uniquely distinctive web site reflecting their business. The unique aspects may include, but are not limited to, using certain layouts, colors, logos, and images.

For example, it is common for businesses to present a coordinated brand or image by using consistent color schemes. The colors may be reflective of their trademarks, products, or packaging. Further, it is well known that certain combinations of colors are viewed as more aesthetically pleasing than other color combinations. There are various types of colors schemes, which include but are not limited to: warm, cool, primary, secondary, complementary, intermediate, analogous, triadic, and monochromatic color schemes. A warm color scheme involves the use of yellows, reds, and orange colors. A cool color scheme involves uses of blue, green, and violet colors. A primary color scheme involves the use of red, blue, and yellow. A secondary color scheme involves the use of orange, green, and violet. A complementary color scheme involves the use of red and green, or yellow and violet, or blue and orange. An intermediate color scheme involves a primary color mixed with a secondary color. An analogous color scheme is any two or more adjacent colors on the well-known color wheel. A triadic color scheme uses any three colors from the color wheel forming a triangle. A monochromatic color scheme involves a color and its tints (color mixed with white) or shades (color mixed with black). As expected, a color in the corresponding scheme can be described as such—e.g., a “warm” color is a color in a warm color scheme.

The collection of color palettes, positioning of web images, page layout, and other presentation aspects used in a web site can be collectively called a “theme,” or the “web theme.” The web theme can be described by a set of parameters termed “thematic parameters.” In certain contexts, which will be evident, certain characteristics of the overall web theme may have their own sub-theme. For example, although a web site can have a theme that comprises colors and images, the color related aspects alone can be referred to as a “color theme.” The reference to the phrase “thematic parameters” as opposed to, e.g., a “color theme” will make clear the distinction.

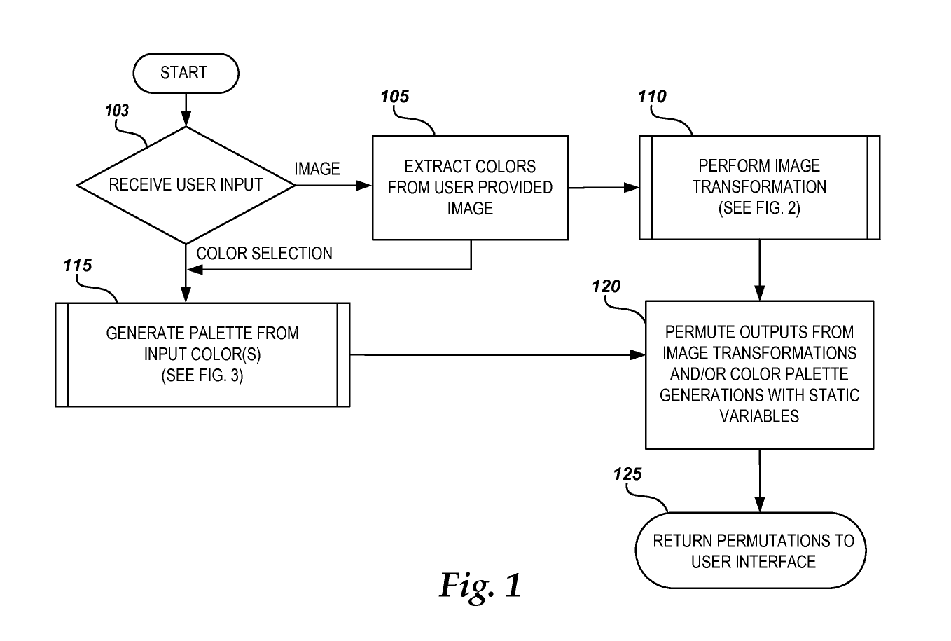

A high level process according to one aspect of the disclosure can be found in FIG. 1. The process starts at block 103 with the user providing input to a theme variation engine comprising either an image, the selection of a color, or both. The “user” in this context is the individual desiring to create the semi-custom web site, and should not be confused with a user accessing the web site once the web site is operational. As it will be seen, the image provided by the user can have color, and the color can be derived from the image. Thus, providing the image can be one form of providing the color. For purposes of illustration, the process in FIG. 1 presumes in block 103 that the user indicates either a color, or an image. In many embodiments, the user will provide both.

Rather than explicitly prompting the user for a color, the theme variation engine may derive the color from a user provided image. In operation 105, the theme variation engine extracts colors from the user provided image. The image can be uploaded from a file selected by the user, and can comprise a variety of colors. In one embodiment, the dominating color present in the image can be selected; other embodiments may select other colors present in the image, or prompt the user to select one of the detected colors. Typically, but not necessarily, the image is a logo or other image that the user desires to incorporate into the web site.

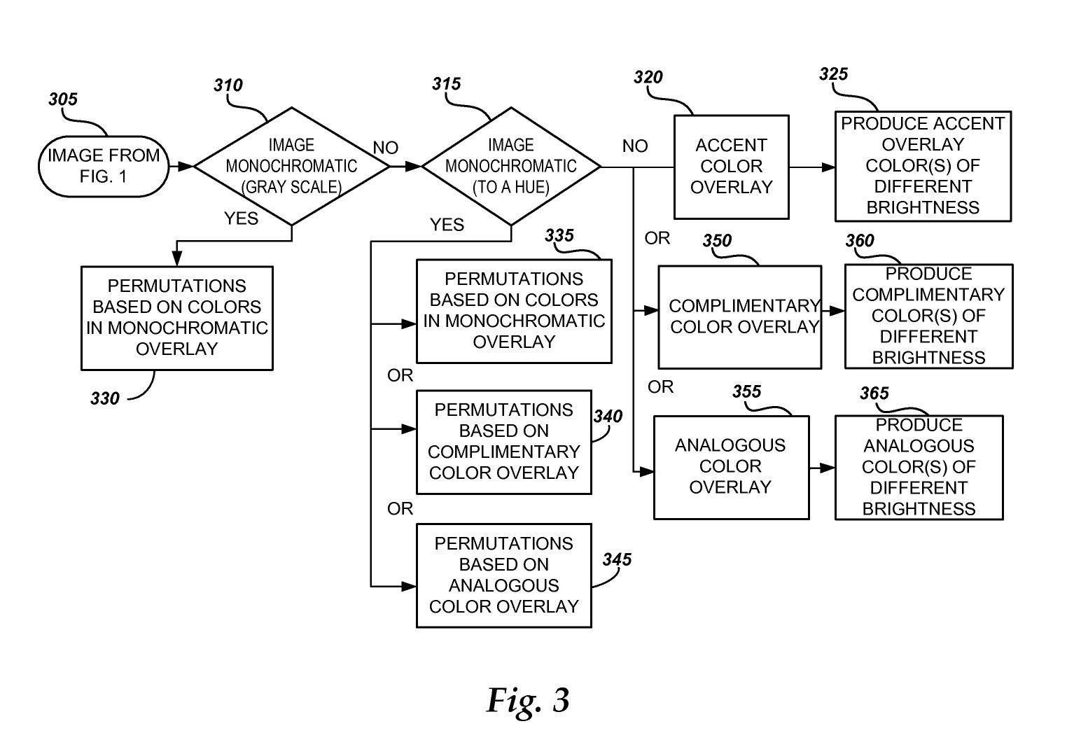

In operation 110, the theme variation engine uses the image and other inputs from the user to perform image transformation. Potential image transformations include altering the colors of the image (e.g., converting to gray scale) or altering the transparency of the image for use as a background image. Further details of this transformation process will be disclosed in conjunction with FIG. 3.

If the user input is directed to indicating or selecting a color to be used in the web theme based on user input directly, then the flow proceeds from operation 103 to operation 115 where a color palette is generated based on the input colors. Typically, but not necessarily, the user selects a color from a plurality of colors presented to the user for selection. Other embodiments are possible, including the user providing numerical indications of the color that can be based on Red Green Blue (“RGB”) values, hexadecimal color codes for specifying colors in HTML, or other proprietary color indication schemes.

In operation 120, the theme variation engine produces a series of outputs based on the image transformations and/or the color palette transformations, along with various static variables. Example transformations include converting the image to a monochromatic color scheme, or altering the transparency, shape, or details. Although the process is shown in FIG. 1 as the user providing either a color or an image, in other embodiments the process may require the user to provide both a color and an image. In other embodiments, the color can be derived from a user provided image. This can be accomplished by merely requesting both inputs from the user or asking the user whether the color should be based on an image input. In other embodiments, a default value can be assumed if the user provides one, but not the other type of input. Namely, in the absence of selecting a color, the color palette may be black and white. In the absence of selecting an image, no image is used, or a null image (e.g., an image without any value) can be used as a default.

The theme variation engine can also prompt the user for static variables such as web page layout including placement of text and incorporation of a user provided image, an associated transformation of the image a type of the image), and color palette usage. Other embodiments may define more or less static variables.

In operation 125, the permutations of the web design are presented to the user by the theme variation engine. The web design permutations are presented using “mock web pages,” typically presented in a thumbnail format that facilitates comparison, and presenting a subset of all the possible permutations. Since the actual web pages have not been constructed at this point, exemplary text may be used in place of the final text. The mock web pages do, however, use the colors, images, and layout that will generally correspond to the final web page layout, after the completed web pages are generated. The theme variation engine generates the thematic parameters, as opposed to defining the textual and functional content of the web pages. However, the theme variation engine may be incorporated into another program that does define these other aspects. Thus, while the theme variation engine may not generate the final web page, it is involved in generating the thematic parameters which defines part of the final web page.

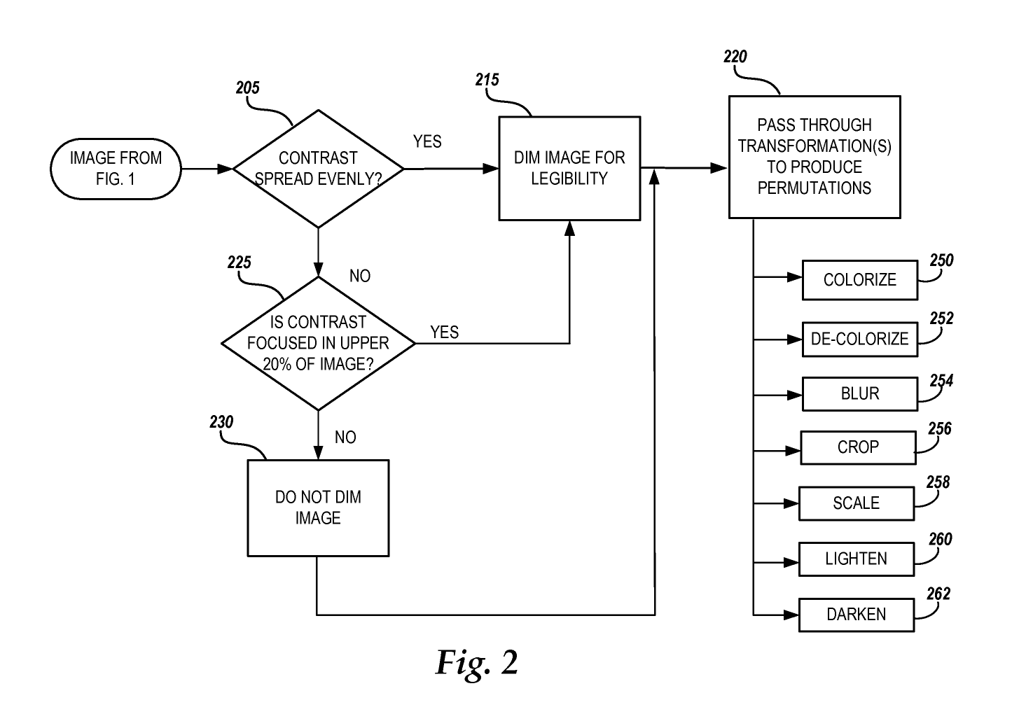

The process of generating image transformations of operation 110 in FIG. 1 is shown in FIG. 2. Turning to FIG. 2, in operation 205 a test is made to determine whether the contrast on the image is evenly distributed or evenly spread. If the contrast is evenly spread, then the image can be dimmed in operation 215. The image may be used as a background or ancillary image on a web page, and in one embodiment, the intensity of the image is dimmed prior to such use. For example, when an image is used as a background image on a web page, it typically should be dimmed so it does not obscure text on the web page.

If in operation 205 the contrast is not spread evenly, then a second test occurs on the image in operation 225 to determine whether the contrast is focused in the upper 20% of the image. Certain images may have a gradual fading in their lower portion, and these types of images may require additional dimming so as to not “compete” with other information that will be presented on the web page, depending on where the image will be positioned. Hence, if the contrast is focused in the upper 20% of the images, then dimming operation 215 occurs. If however, the contrast is not focused in the upper 20% of the image, then dimming operation 225 may be skipped, and theme variation engine may use the resulting image in operation 220 to produce one or more transformations of the image.

The image transformations are shown as operations 250-262. These operations may occur singly, or in combinations. The colorize operation 252 involves adding color to the image. This can involve filing spaces with color or changing line colors. Various algorithms can be used to add color if none is present. The theme variation engine may prompt the user to select a color to use in the image transformation. The decolorize operation 252 involves removing color, and converting spaces and/or lines to a black and white, or gray-scale scheme. In the blur operation 254, a blurred and/or fading of the edges may be applied to the image.

In the crop operation 256, portions of the image may be cropped to size. For example, any portion protruding a certain amount from a polygon surrounding the image may be cropped. In the scale operation 258, the image may be enlarged or shrunk to fit an allocated area. In the lighten operation 260, the color or hue of the image may be lightened. Finally, in the darken operation 262, the color or hue may be darkened.

It is possible that multiple operations may be performed on an image. For example, a user provided image in the form of a picture may be used as a background image. It can be desirable to convert the image to a cropped, black and white image that is lightened so as to not distract from the rest of the web page. However, in other embodiments, the image may be a logo that is positioned on a certain area of a web page. In this case, the logo image may have to be resized or cropped to fit within a certain area of a web page. In this case, the color, contrast, and details of the logo are not modified.

As noted previously, the selection of a color may be derived from at least two sources—the color can be explicitly indicated by the user, or the user can provide an image from which the color is derived. Assuming that the user separately provides an image, FIG. 3 discloses one embodiment of generating a color palette for the web site based on the user provided image. In operation 310, the theme variation engine analyzes the image to ascertain if it is a gray-scale monochromatic image. Gray scale monochromatic images include black and white images, as well as gray-scale images. If the image is a gray-scale monochromatic image, then operation 330 will generate various permutations based on one or more colors. In some embodiments, the user may provide input as to the color family or range.

The provision of colors may be controlled by various monochromatic overlay rules. An exemplary list of color use rules are provided below:
1) Pure red: must be less than 100% saturation, and the image should be tinted to 10-60% with the chosen color, or image should be shaded to 10-80% with the chosen color.
2) Pure blue: any random settings for tint or shade of the image are valid.
3) Pure yellow: must be less than 100% saturation, and the image should be tinted to 10-60% with the chosen color, or image should be shaded 10-90% with the chosen color,
4) Pure green: any random settings for tint or shade of the image are valid.
5) Pure purple: any random settings for tint or shade of the image are valid.
6) Pure orange: any random settings for tint or shade of the image are valid,
7) Yellow green (R200 G255 B0-R254 G255 B0): must be less than 100% saturation, image should be tinted to 10-60% with the chosen color, or image should be shaded to 10-80% with the chosen color.
8) Red/Purple (R255 G0 B255): must be less than 100% saturation, image should be tinted to 10-60% with the chosen color, or image should be shaded to 10-80% with the chosen color.
   The above rules are intended to avoid certain colors which, when displayed on a computer monitor, can be difficult for some people to view on a computer monitor. These rules can be considered as aesthetic type rules, which ensure that the resulting color palette is aesthetically pleasing. Certain rules could also be classified as functional type rules, to ensure that the function of the web page is accomplished.

If, in operation 310, the image is not a gray-scale monochromatic image, operation 315 determines if the image is monochromatic with respect to a hue. If so, then various transformations on the image are possible and it is possible that more than one transformation on the image may be performed and presented to the user. For example, in operation 335 the theme variation engine may transform the image by using a monochromatic color overlay. For example, a varying brightness (e.g., within 10%) of the same color can be applied to the image. In operation 340, a complimentary color overlay is produced by selecting complementary colors to the main color of the image. The complementary colors may have at least a 20% variation in brightness in one embodiment. In operation 345, an analogous color overlay is selected where the colors have a 20% contrast with respect to the main color of the image. The above identifies only several potential transformations that can be carried out on a monochromatic image. Other color palettes could be selected based on other rules.

If the image is not monochromatic in operation 315, i.e., if it is polychrome, then one of several other transformations can occur, depicted as operations 320, 350, and 355. In operation 320 an accent color overlay can be selected by producing accent overlay colors in step 325 that have different levels of brightness. Various rules may stipulate minimum threshold levels of brightness, which can be 10% in one embodiment. In operation 325 a complimentary color overlay is selected where in operation 360 different complimentary colors of different brightness may be applied to the image. Finally, operation 335 involves selecting an analogous color overlay that may apply in operation 365 analogous colors to the image. Other potential transformations can be carried out on a polychrome color image. Additionally, rules may be defined by the theme variation engine as to when each color palette can be construed, and limitations as to what colors can be used in each palette. Certain color combinations may be avoided, because they do not replicate as well on a computer monitor.

Certain of the rules may be more functionally rather than aesthetically oriented. For example, a small scale image provided by the user may not scale well. Thus, some image transformation rules may not allow an image to be used as an overall background image. In another embodiment, the user may provide an image that is indicated as a logo. An image transformation rule can be defined for processing logo images in a distinct manner. For example, the colors associated with a logo may be part of a trademark, and should not be altered. Or the borders of a logo should not be blurred. However, the size, and transparency of a logo image could be altered. On the other hand, if the user indicates the image is a photograph, a different set of transformation rules may allow changing colors. Different embodiments of the theme variation engine may request an indication of the type of image, and have different functional rules associated therewith.

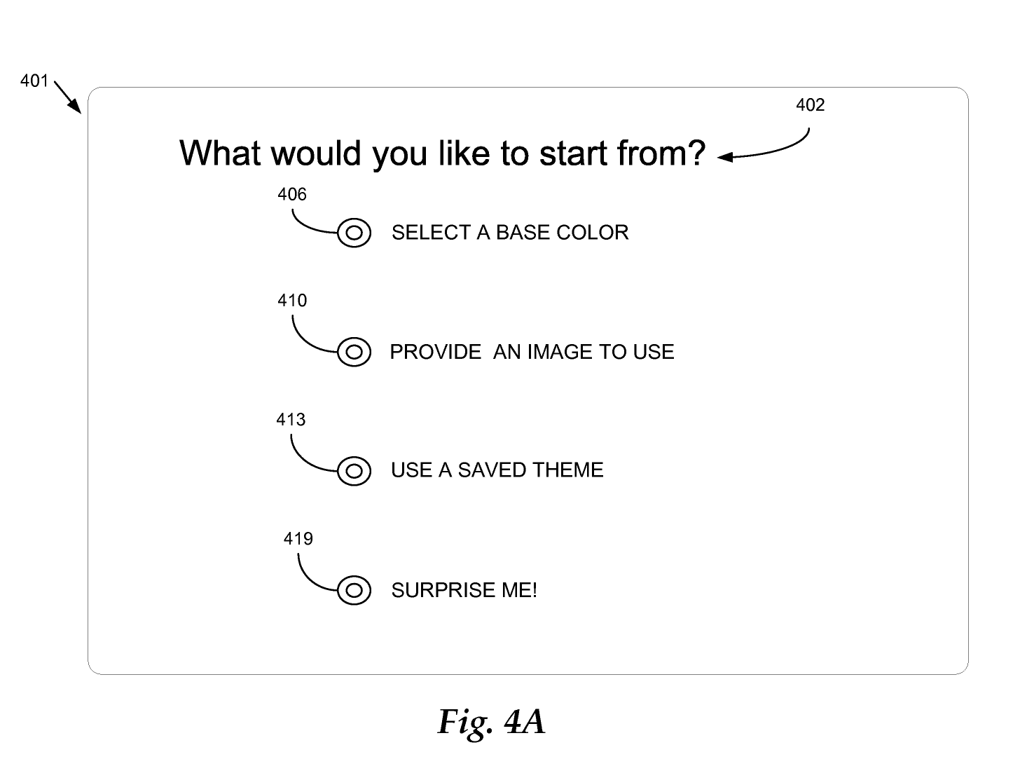

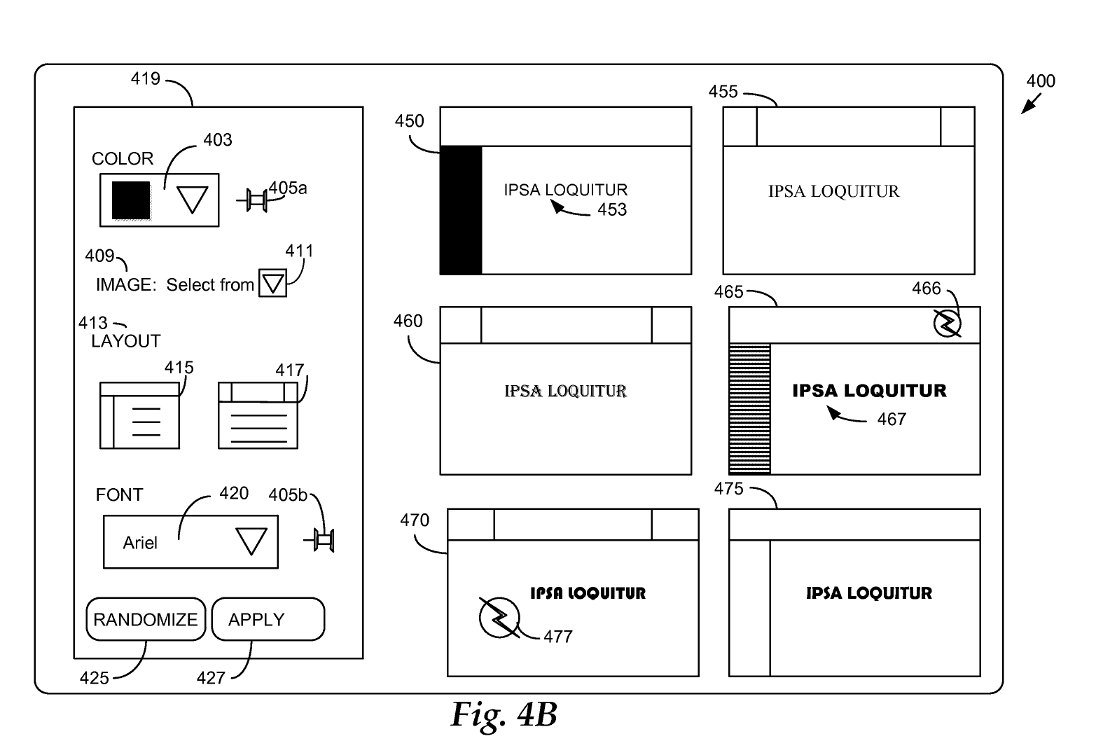

The process illustrated in FIG. 1 may be associated with a user interface 401 as shown in FIG. 4A, FIG. 4A illustrates a prompt 402 provided to the user for indicating how a web page should be customized. Option 406 is prompting the user to select a base color, which can lead to other prompts for inputting color information. The prompt 410 solicits user input to provide an image. Typically, the image is uploaded from a file on the user's computer, and can be in any of the various formats for indicating an image, including but not limited to: JPEG, TIFF, GIF, PNG, BMP, RIFF, etc.

A user may save a theme (e.g., a set of thematic parameters) for future use. The thematic parameters can be used in generating a functional web page, or for generating additional sets of thematic parameters and the thematic parameters can be saved in a file format which can housed later to illustrate a mock web pages. Thus, one option 413 is to return to review a previously saved theme, and allow the user to refine, modify, or add to the theme selections. Finally, prompt 419, if selected, allows the user to request that the theme variation engine present various combinations without selecting a particular thematic parameter value. In one embodiment, these can be random combinations of various color and static values. In other embodiments, the theme variation engine can collect information regarding themes commonly used by users, and present a library of the most common themes to the user.

FIG. 4B illustrates another embodiment of a user interface 400 for receiving user input, which allows the user to select a color, provide an image, and select static variables such as web page layout and font, in FIG. 4B, a user interface control 419 is presented to the user allowing input selection. One icon 403 requests the user to indicate a color, using an expanding drop down menu. Once the desired color is selected, the user can “pin” the color (e.g., select a color value for use by selecting the pin icon) by using pin icon 405a. In other embodiments, the user may indicate a numerical value of the color, or select from a name on a menu. Another user interface control 409 allows the user to indicate an image. The user may select various sources or methods for indicating a file containing the image using icon 411, including indicating a URL, destination file, or other source.

Another user interface control 413 allows the user to indicate a web page layout. In this embodiment, only two different formats 415 and 417 are shown for the sake of illustration, although more options can be indicated in other embodiments. In this illustration, the two formats are different in that format 415 has a different template header and sidebar layout than format 417. Various differences in the layout, text positioning, and color application can be indicated in the formats 415 and 417. Another user interface control 420 allows the user to select a font style to be used, as well as image and layout. The user's selection can be pinned using icon 405b.

In this embodiment, the user can apply any of the above indicated values by then selecting the APPLY user interface control 427. Alternatively, the user can select the RANDOMIZE 425 user interface control to instruct the theme variation engine to select its own values for those not pinned. If the user does not indicate any theme related values, then the theme variation engine selects all aspects of the theme for the user. If the user does not indicate an image, then in one embodiment, no image is used. In another embodiment, the theme variation engine can use a stock image in some mock web pages along with potential treatments of the image.

The number of theme combinations that can be produced can be quite large. For example, assume that the user provides a color for a theme and an image. Assume that there are six color palettes associated with the color, and six image transformations that could be performed on the image. If there are eight different layout formats and twelve different fonts, then there are 6×6×8×12=3,456 permutations. It is not practical to display all of these options to the user. Typically, a small number such as eight to twelve mock web pages can be presented on a display page to the user. When the user selects the user interface control 427, the subset of the resulting mock web pages can be selected at random. Thus, even when using the same inputs, the user may not view the same subset of outputs.

FIG. 4B shows six such exemplary web pages displayed. Mock web pages 450, 465, 460, 465, 470, and 475 are variations that represent randomized inputs. The mock web pages are intended to illustrate how the thematic parameters would result in an exemplary web page, without the theme variation engine having to generate a complete functioning web page. Generating the complete functioning web page can take significant computing resources, and doing so for each combination would unnecessarily expend computing resources. It is not necessary to do so to only illustrate the thematic combinations to the user. Typically, the text on a mock web page is provided for illustration purposes only. In FIG. 4, the text shown is provided by the theme variation engine, not user input.

In one embodiment, the user does not indicate an image and the theme variation engine operating using a “null” image. In other embodiments, the user may indicate an image, and may further indicate the nature of the image. For example, the user may indicate the image is a logo, which may impact how the transformation of the image is done. Typically, logos incorporate defined colors, so the rules defining how the transformation is performed on a logo may be different than a transformation performed on a photograph.

The mock web pages are exemplary and are for the purpose of visually illustrating various web page themes. Thus, it will be noted that each mock web page may incorporate some mock text 453. After the user selects a theme, and actually constructs the web page, then the user supplied text will be provided on the final web pages that are accessible. At this point, the function of the mock text 453 is to indicate a font that can be used, and mock text allows the user to determine whether the font is preferred. Other fonts 467 are shown. As can be seen, each of the layouts shown has configurations in accordance with layout 415 or 417. For example, mock web page 450 has a colored section, which is different from colored section in mock web page 465 correspond to layout 415. (Different colors are represented by solid black and/or shading.) In addition, some mock web pages can incorporate an image 466 and 477 which are placed in different locations. This can be a stock image, or can be an image provided by the user. The system may limit the number of mock web pages generated as a subset of the total number of combinations.

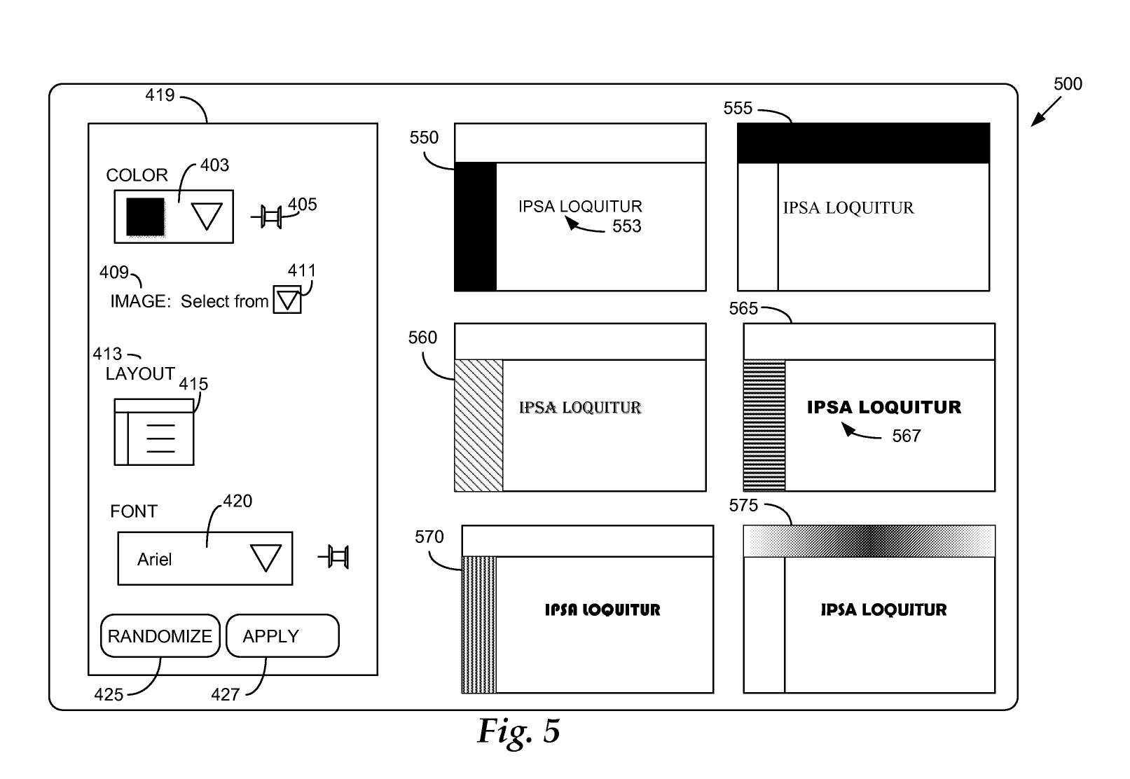

FIG. 5 illustrates a user interface 500 depicting the same control panel 401, but where the user has selected a single web page layout 415. The user can indicate that this layout should be applied “pinned”) and that the other variables are to be randomized. Once an aspect has been selected, the pushpin icon can change shape reflecting the user's selection. The resulting mock web pages 550, 555, 560, 565, 570, and 575 all have the same general layout configuration, but have different fonts 553, 567 for the text, and different color layout (indicated by the various shading patterns). The color and placement of the color on each mock web page can vary, although the format is the same.

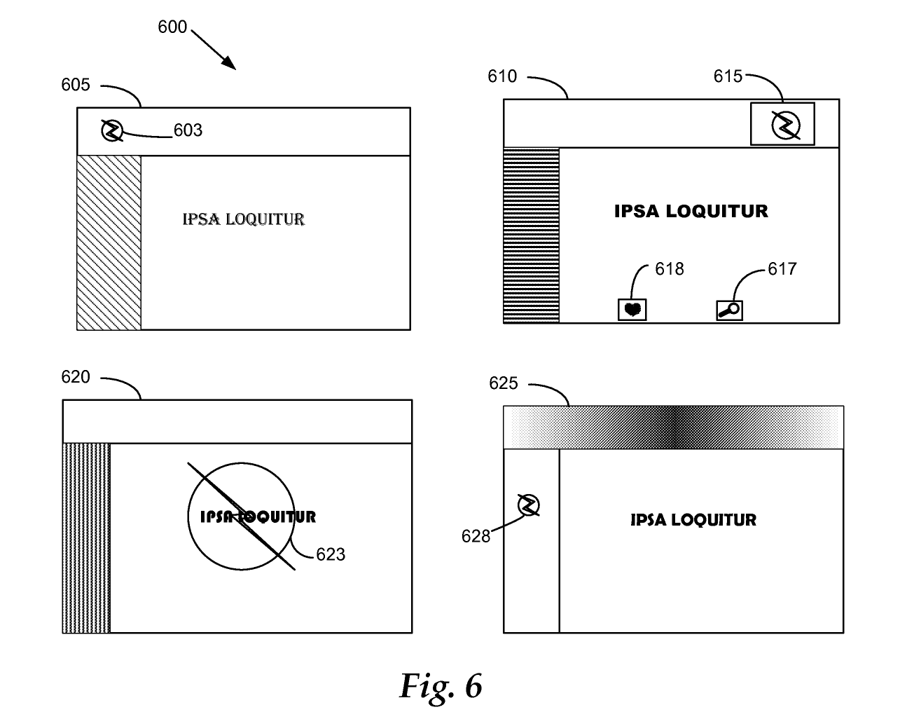

In FIG. 6, another set of mock web pages are shown, but without the control panel to facilitate illustration of the mock web pages. In this illustration, only four mock web pages are shown, again to facilitate illustration. In this embodiment, the user may have provided an image to incorporate into the format. This could be, e.g., a logo of the user's company, and the user desires that the web page incorporate the logo. Thus, in mock web page 605 the image 603 is shown in the upper corner whereas in mock web page 610 the image 615 is in the upper right corner, positioned within a box. In mock web page 620 the image 623 is in the center of the web page. In such cases, it is preferred that the image be dimmed, so as to not interfere with the legibility of the text. In mock web page 625, the mock image 628 is positioned at the left side.

These examples illustrate to one skilled in the art how various inputs selected by the user can be processed to generate a plurality of mock web pages for presentation to the user, so that the user can then select a combination of thematic parameters. The user can select certain themes, and save the associated thematic parameters for future use. The user can provide certain inputs and have the theme variation engine randomize other values. The user can indicate preference for a particular theme by selecting the mock web page. Once the mock web page is selected (e.g., by right clicking the mouse), icons, such as a heart icon 618 and a magnifying glass 617 may be superimposed upon the display of the mock web page. The user can select the heart icon 618 to save the thematic parameters, or select the magnifying glass to magnify or further inspect aspects of the mock web page. Other icons or indications can be used.

The generation of the mock web pages can be performed in one implementation by generating thumbnail images based on style sheets, A thumbnail file is generated for each mock web page incorporating tokens representing the thematic parameters such as color and layout. As the theme variation engine generates particular values of the parameters, these are inserted into the file to generate the mock web page. Each file can be represented, for example, by the following pseudo code:

/_catalogs/theme/Azure.spthmx
[SECTION]
[ID] #pageContainer
{

width: 100%;
height: 100%;
background-color: [T_DARK1_MEDIUM];
color: [T_ACCENT1_LIGHTER];

}
[SECTION]
<div id=”pageContainer”>

<div class=”pageTitle”>

[PAGE_TITLE]

</div>

</div>

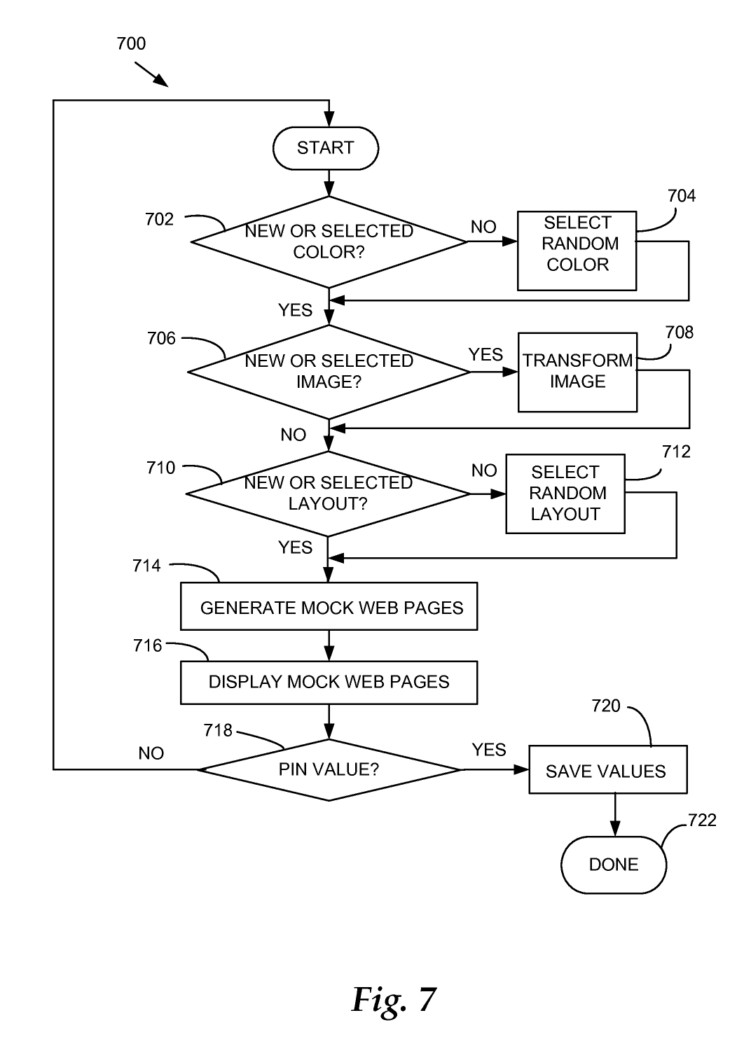

A process flow 700 for generating the mock web pages is shown in FIG. 7. It should be appreciated that the logical operations described herein with respect to FIG. 7 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should also be appreciated that more or fewer operations may be performed than shown in the FIGURES and described herein. These operations may also be performed in a different order than those described herein

The process 700 starts in operation 702 with the theme variation system determining a color value newly that is indicated, or previously selected by the user. If the user is indicating a new value, this can be indicated using the aforementioned drop down menus or other input prompting methods. If the user has previously selected a value, then the theme variation engine will use this value. If there is no color value indicated or selected, then the theme variation engine in Operation 704 will randomize a color value by selecting a color.

The process 700 then proceeds according to FIG. 7 to operation 706 where the theme variation engine determines if the user is indicating a new image or selecting to use a previously indicated image. If the user does indicate a new value, or uses a previously selected value, then the theme variation engine will transform the image in operation 708.

The process 700 proceeds according to FIG. 7 to operation 710 where the theme variation engine determines whether there is a layout format indicated or previously selected by the user. If the user is indicating a new value, this can be indicated using the aforementioned user interface controls or other user interface mechanisms. If the user has previously selected a layout generated by the theme variation that was saved, then the theme variation engine will use this value. If there is no layout indicated or selected, then the theme variation engine in operation 704 will randomly select the layout.

In the above process, the theme variation engine may select the color or layout in a random manner. However, other algorithms can be used, such as determining a relative frequency of selection of the thematic parameter by others, or having characteristics related to previously selected values by the user. While the theme variation engine may select a color or layout in the absence of user input, it typically does not select an image if one has not indicated by the user. However, in other embodiments, the user may indicate a characteristic of an image, and request the theme variation engine to select an image or prompt the user for selected recommended images in some manner. For example, a user desiring to incorporate photos of wildlife as a background image may request the theme variation engine to select a wildlife image using an internal library.

After the theme variation engine has determined the user's input with respect to color, image, and layout, then in operation 714 the theme variation engine generates the mock web pages. In operation 716, the theme variation engine will display the mock web pages to the user. In one embodiment, the theme variation engine generates a subset of the mock web pages, as opposed to generating all permutations. Typically, a fixed number of mock web pages will be presented to the user, which can be a subset of those generated, and the user can access various pages using conventional paging techniques. The theme variation engine may present the subset of the generated mock web pages based on a certain algorithm.

In operation 718, the user can select and pin certain attributes associated with a selected mock web page. Specifically, the user can pin a color combination, page layout, or image transformation generated and presented by the theme variation engine. The results can be used to repeat the process, looping back to operation 702, and generating another round of mock web pages. Thus, a user can request an initial round of mock web pages to be generated, select a particular color palette in one of the mock web pages, and then request that another set of mock web pages be generated using the selected color palette.

Once the user is happy with the results, the thematic parameters can be saved in operation 720 and associated with the user. The user can return at a later time, requesting further variations to be generated using saved thematic parameter values, or the thematic parameters can be further changed and additional mock web pages can be generated. Once the theme parameters have been defined, another module can be used to generate the actual web pages for the user. In that case, the user can merely specify the selected set of thematic parameters, and does not have to define for each possible instance the layout, color, and image transformation to be used.

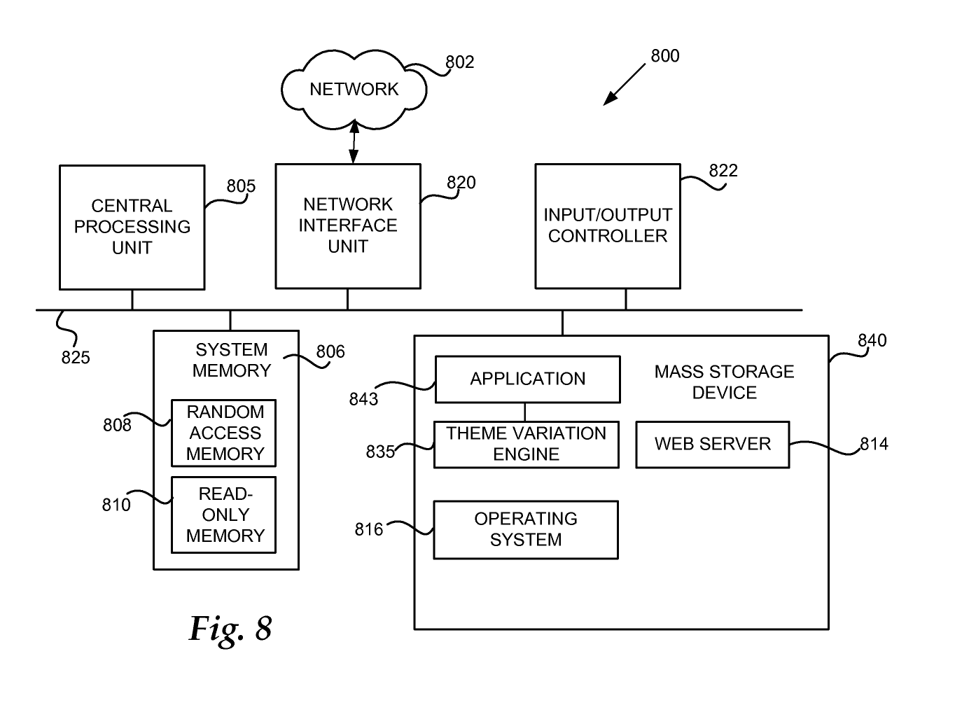

FIG. 8 illustrates exemplary computer architecture for a computer 800 capable of executing the software components described herein for executing the theme variation engine. The computer architecture shown in FIG. 8 illustrates a conventional desktop, laptop, or server computer and may be utilized to execute any aspects of the software components presented herein.

The computer architecture shown in FIG. 8 includes a central processing unit 805 (“CPU”), a system memory 806, including a random access memory 808 (“RAM”) and a read-only memory (“ROM”) 810, and a system bus 825 that couples the memory to the CPU 805. A basic input/output system containing the basic routines that help to transfer information between elements within the computer 800, such as during startup, is stored in the ROM 810. The computer 800 further includes a mass storage device 840 for storing an operating system 818, application programs, and other program modules, which are described in greater detail herein.

The mass storage device 840 is connected to the CPU 805 through a mass storage controller (not shown) connected to the bus 825. The mass storage device 810 and its associated computer-readable media provide non-volatile storage for the computer 800. Although the description of computer-readable media contained herein refers to a mass storage device, such as a hard disk or CD-ROM drive, it should be appreciated by those skilled in the art that computer-readable media can be any available computer storage media that can be accessed by the computer 800.

By way of example, and not limitation, computer-readable media may include volatile and non-volatile, removable and non-removable media implemented in any method or technology for storage of the non-transitory information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800.

According to various embodiments, the computer 800 may operate in a networked environment using logical connections to remote computers through a network such as the network 802. The computer 800 may connect to the network 802 through a network interface unit 820 connected to the bus 825. It should be appreciated that the network interface unit 820 may also be utilized to connect to other types of networks and remote computer systems. The computer 800 may also include an input/output controller 822 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 840 and RAM 808 of the computer 800, including an operating system 816 suitable for controlling the operation of a networked desktop, laptop, or server computer. The mass storage device 810 and RAM 808 may also store one or more program modules such as the theme variation engine program module 835 and application program 843. The theme variation engine 835 can operate in cooperation with the application program 843. In one embodiment, the application program 843 generates the web site and uses the theme variation engine module 835 to determine a theme for the web site. In other embodiments, the theme variation engine can be incorporated into the application program itself. The mass storage device 810 and the RAM 808 may also store other types of program modules and data, including the web site module 814 that can host the web site after the web site with the appropriate theme is generated by the theme variation engine 835 and/or the application program 843.

It should be appreciated that the software components described herein may, when loaded into the CPU 805 and executed, transform the CPU 805 and the overall computer 800 from a general-purpose computing system into a special-purpose computing system customized to facilitate the functionality presented herein. The CPU 805 may be constructed from any number of transistors or other discrete circuit elements, which may individually or collectively assume any number of states. More specifically, the CPU 805 may operate as a finite-state machine, in response to executable instructions contained within the software modules disclosed herein. These computer-executable instructions may transform the CPU 805 by specifying how the CPU 805 transitions between states, thereby transforming the transistors or other discrete hardware elements constituting the CPU 805.

Encoding the software modules presented herein may also transform the physical structure of the computer-readable media presented herein. The specific transformation of physical structure may depend on various factors, in different implementations of this description. Examples of such factors may include, but are not limited to: the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 800 in order to store and execute the software components presented herein. It also should be appreciated that the computer 800 may comprise other types of computing devices, including hand-held computers, embedded computer systems, personal digital assistants, and other types of computing devices known to those skilled in the art. It is also contemplated that the computer 800 may not include all of the components shown in FIG. 8, may include other components that are not explicitly shown in FIG. 8, or may utilize an architecture completely different than that shown in FIG. 8.

Based on the foregoing, it should be appreciated that technologies for generating varied themes are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A system for generating thematic parameters for use in a web site comprising:
a central processing unit;
a network interface unit configured to receive input provided from a user; and
a mass storage device storing a theme variation engine program module indicating program instructions that when executed causes the central processing unit to
receive input from a user indicating a color to be used in the web site,
determine a color palette based on the color indicated by the user, the color palette comprising at least two colors wherein one color is the color provided by the user and another color is one of an accent color, a complimentary color, or an analogous color,
receive input indicating a web page layout from the user to be used in the web site,
generate a first plurality of mock web pages incorporating the web page layout and the color palette, and
display a second plurality of mock web pages to the user.

2. The system of claim 1 wherein program instructions when executed further cause the central processing unit to:
receive input from the user indicating an image file to be incorporated into the web site; and
wherein generating a first plurality of mock web pages further comprises generating the first plurality of mock web pages incorporating a transformation of the image.

3. The system of claim 1 wherein the program instructions when executed further cause the central processing unit to:
receive input from the user indicating a selected mock web page; and
store a set of thematic parameters associated with the selected mock web page.

4. The system of claim 2 wherein the program instructions when executed further cause the central processing unit to:
determine the color based on a predominate color in the image file.

5. The system of claim 1 wherein the second plurality of mock web pages displayed is a subset of the first plurality of mock web pages generated.

6. The system of claim 2 wherein a set of transformation rules used to transform the image is based on input from the user indicating a type of image in the image file.

7. A computer implemented method to generate a set of thematic parameters for a web site comprising:
receiving input from a user indicating a color to be used in the web site;
determine a first color palette based on the color indicated by the user, the first color palette comprising at least two colors wherein one color is the color provided by the user and another color is one of an accent color, a complimentary color, or an analogous color;
generating a plurality of mock web pages including a first mock web page incorporating a first web page layout and the first color palette, and a second mock web page incorporating a second web page layout and the first color palette; and
displaying the plurality of mock web pages to the use.

8. The method of claim 7 further comprising:
receiving input from the user indicating an image file to be incorporated into the web site; and
wherein generating the plurality of mock web pages comprises generating the first mock web page incorporating a transformation of the image.

9. The method of claim 8 wherein generating a plurality of mock web pages further comprises generating the second mock web page incorporating a different transformation of the image than the first mock web page.

10. The method of claim 7 further comprising;
receiving input from the user selecting the first web page layout associated with first mock web page; and
generating a second plurality of mock web pages incorporating the first web page layout.

11. The method of claim 7 further wherein generating plurality of mock web pages includes generating a third mock web page using a second color palette.

12. The method of claim 11 further comprising:
receiving input from the user selecting the second color palette of the third mock web page;
receiving input from the user requesting generating a second plurality of mock web pages wherein each second plurality of mock web pages uses the second color palette of the third mock web page.

13. The method of claim 7 further comprising:
receiving input from the user selecting one of the plurality of mock web pages; and
storing the set of thematic parameters for the user in a memory associated with the selected one of the plurality of mock web pages.

14. A computer readable storage medium having computer readable instructions stored thereupon that, when executed by a computer, cause the computer to:
receive input from a user, the input comprising an image file;
select a color from the image file, wherein the color is a predominate color in the image file;
generate a first color palette comprising a plurality of colors, where one of the plurality of colors is the color from the image file;
receive input from the user indicating a web page layout;
generate a first plurality of mock web pages incorporating the web page layout and the first color palette;
display the first plurality of mock web pages to the user; and
receive a second input from the user, the second input requesting generating a second plurality of mock web pages wherein the second plurality of mock web pages is different from the first plurality, and wherein at least two of the second plurality of mock web pages incorporate distinct transformations of the image.

15. The computer readable storage medium of claim 14 wherein the instructions further cause the computer to:
receive an input from the user indicating a type of image; and
determine a set of transformation rules used to transform the image based on the type of image.

16. The computer readable storage medium of claim 15 wherein the instructions further cause the computer to:
receive an input from the user indicating the type of image is a logo.

17. The computer readable storage medium of claim 14 wherein the instructions further cause the computer to generate a second color palette incorporating the color, and wherein generating the first plurality of mock web pages comprises a second mock web page incorporating the second color palette.

18. The computer readable storage medium of claim 14 wherein the instructions further cause the computer to:
receive input from the user selecting the second mock web page; and
determine a set of thematic parameters associated with the second mock web page; and
store the set of thematic parameters for use in constructing a web site for the user.

19. The computer readable storage medium of claim 14 wherein the instructions further cause the computer to transform the image by altering the transparency of the image.

20. The computer readable storage medium of claim 14 wherein the color palette comprises three triadic colors.
